(19) United States
(12) Patent Application Publication
(10) Pub. No.: US 2014/0095818 A1
(43) Pub. Date: Apr. 3, 2014

(54) UPDATING SYSTEM AND METHOD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/865,241

(22) Filed: Apr. 18, 2013

(30) Foreign Application Priority Data
Sep. 29, 2012 (CN) 201210374697.X

(51) Int. Cl. G06F 3/06

(52) U.S. Cl. CPC G06F 3/0619; G06F 3/065; G06F 3/0673
USPC 711/162

(57) ABSTRACT

An updating system includes an input unit, a recording unit, and a processor. The input unit generates updating data for updating a to-be-updated file in response to users operations. The processor updates the to-be-updated file using the updating data generated in response to users operations. The recording unit creates a duplicate record for recording the updating data during the procedure of updating the to-be-updated file. If the updating system is powered off before the to-be-updated file has been updated, the processor can obtain the duplicate record to update the to-be-updated file when the updating system is again powered on. An updating method applied in the updating system is also provided.

### BACKGROUND

1. Technical Field

The present disclosure relates to updating systems and method, and more particularly to an updating system and method capable of protecting the updated data from loss when an unanticipated loss of power occurs.

2. Description of Related Art

Updating systems, such as those in computers, allow users to input data for updating files and/or settings in computers. However, the inputted data may be lost if there is an unanticipated loss of power, and users have to attempt to input data again after the systems restarts, which is time consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an updating system in accordance with an embodiment.

FIG. 2 is a flowchart of an updating method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

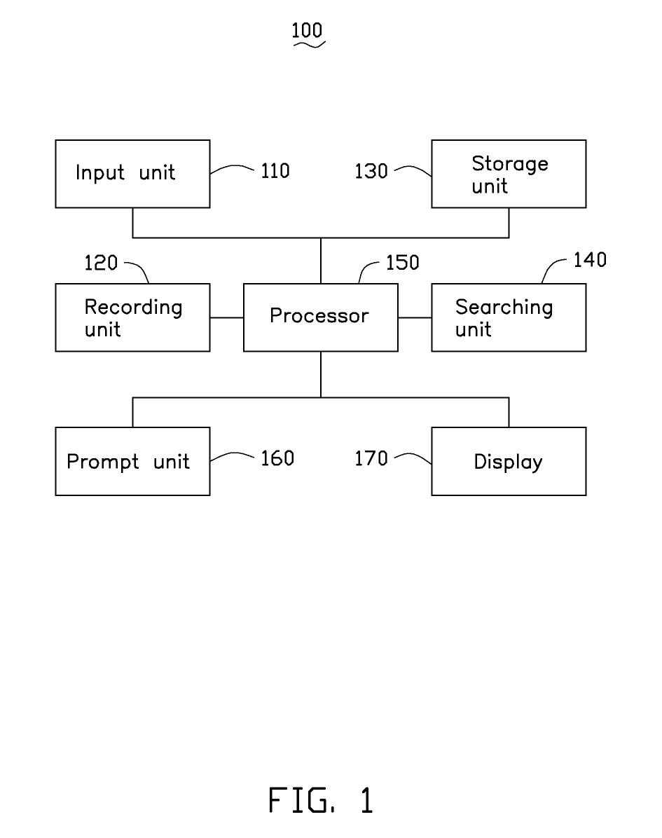

Referring to FIG. 1, a blocking diagram of an updating system 100 capable of generating updating data for updating a to-be-updated file in response to user operations is illustrated. The updating system 100 creates a duplicate recording of the updating data during the updating procedure, to protect the updating data from being lost when an unanticipated loss of power occurs. If an unanticipated loss of power does occur before the to-be-updated file has been updated, the updating system 100 utilizes the duplicate recording to update the to-be-updated file when the updating system 100 is powered on again, to avoid users re-entering the updating data once more. The updating system 100 may be contained in a computer, a portable DVD player, or a set-top box. The updating system 100 in the embodiment is contained in a portable DVD player.

The updating system 100 includes an input unit 110, a recording unit 120, a storage unit 130, a searching unit 140, and a processor 150. The updating system 100 further includes a prompt unit 160 and a display 170.

The input unit 110 generates updating data for updating the to-be-updated file in response to user operations. The input unit 110 can be a keyboard having a plurality of keys and/or buttons, or a touch panel mounted on the updating system 100, and can also be a remote device for remotely controlling the updating system 100.

The recording unit 120 creates a duplicate record corresponding to the to-be-updated file for recording the updating data during the updating procedure. When users input the updating data via the input unit 110, the recording unit 120 simultaneously records the updating data. For convenient access to the duplicate record, each duplicate is named with the combination of the name of the to-be-updated file and the time of recording of the duplicate. For example, a duplicate record named “Contacts20120523,” means that the duplicate with the name Contacts20120523 corresponds to the Contacts file (the to-be updated file), and was created on May 23, 2012.

The storage unit 130 stores the duplicate and other data, such as images, video, and parameters. The storage unit 130 in the embodiment is an Electrically Erasable Programmable Read-Only Memory (EEPROM) device.

When the updating system 100 is activated to update a to-be-updated file, the searching unit 140 determines whether a duplicate record corresponding to the to-be-updated file is stored in the storage unit 130. The searching unit 140 generates a first signal if no duplicate recording is found, and generates a second signal if a duplicate recording is found. In the embodiment, the searching unit 140 firstly obtains the name of the to-be-updated file, and further detects whether the name of the to-be-updated file matches with the name of the duplicate recording, and then determines if a duplicate record corresponding to the to-be-updated file has been stored in the storage unit 130 with the name of the to-be-updated file.

The processor 150 carries out instructions of the updating system 100 by performing the basic arithmetical, logical, and input/output operations of the updating system. When receiving the first signal generated by the searching unit 140, the processor 150 updates the to-be-updated file according to the inputted updating data generated in response to users operations. When receiving the second signal, the processor 150 obtains the duplicate record stored in the storage unit 130, to update the to-be-updated file. The processor 150 further detects whether the to-be-updated file has already been updated, and generates a warning if the to-be-updated file has been not updated. In the embodiment, the updating system 100 provides a special key for the completion of the updating procedure, and the processor 150 determines that the updating of the to-be-updated file is completed (that is, remaining to be done) when the special key is activated.

The prompt unit 160 generates a warning message to inform users that the to-be-updated file has not been updated. The warning message may be an animation or some other interesting image displayed on the display 170. In another embodiment, the message may be an audio message outputted by a speaker (not shown).

For better understanding of the present disclosure, a to-be-updated file for the purposes of exemplifying the present embodiment is the Contacts file, for example, the Contacts file exists, but needs to be updated (first update) at the present time of Sep. 20, 2012.

The updating system 100 is activated to update the Contacts file in response to user operations. The searching unit 140 determines whether a duplicate record corresponding to the Contacts file is stored in the storage unit 130. Because the Contacts item of the updating system 100 has not previously been updated, no duplicate record (for the first update) is stored, and the searching unit 140 generates a first signal. The processor 150 updates the Contacts item according to the inputted data which is generated in response to the user operations. Simultaneously, the recording unit 120 creates a duplicate record named Contacts20120920 recording the inputted updating data (to, for example, Sep. 20, 2012). When the time Sep. 20, 2012 is inputted during the updating procedure, if an unanticipated loss of power occurs before the Contacts item has been updated, the inputted data for Sep. 20, 2012 is protected from loss by being recorded in a duplicate record named “Contacts20120920.”

When the updating system 100 is powered on again, the searching unit 140 determines whether a duplicate record corresponding to the Contacts item is stored in the storage unit 130. The duplicate record named Contacts20120920 is found, and the searching unit 140 generates a second signal. The processor 150 obtains the duplicate named Contacts20120920 to update the Contacts file to Sep. 20, 2012. As a result, users do not need to re-enter the updating data again, and a waste of time is avoided.

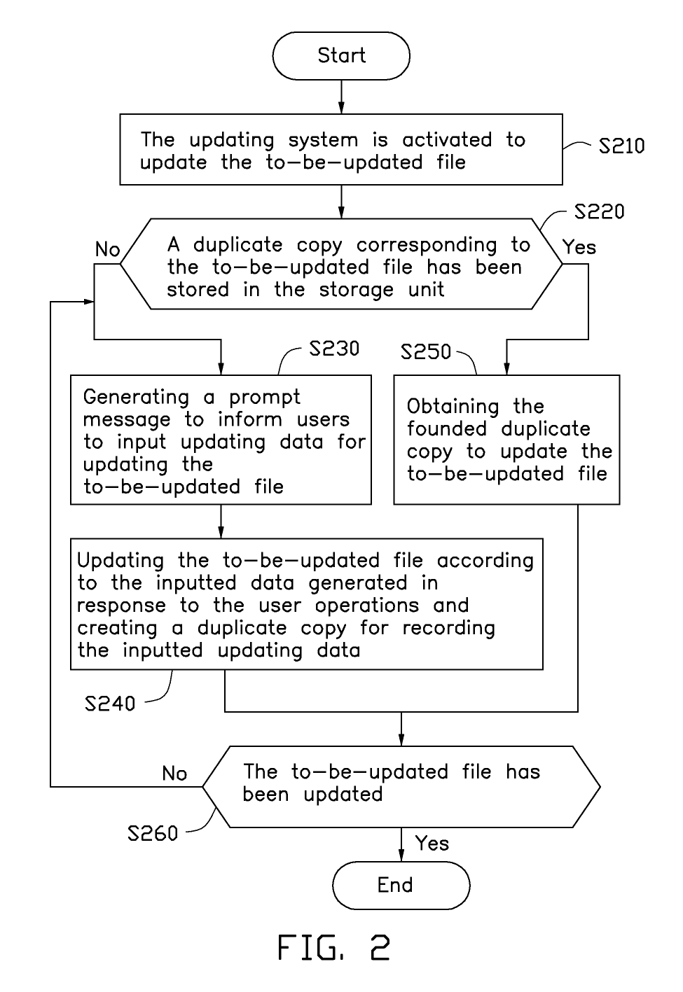

Referring to FIG. 2, an updating method for updating to-be-updated file is provided. The method is applied in the updating system 100. The updating system 100 may be contained in a computer, a portable DVD player, or a set-top box. The method includes the following steps:

In step S210, the updating system 100 is activated to update the to-be-updated file. A menu item may be provided for activating the updating system 100 to enter the updating procedure.

In step S220, the searching unit 140 determines whether a duplicate recording corresponding to the to-be-updated file has been stored in the storage unit 130. If no duplicate record corresponding to the to-be-updated file is found, the procedure goes to step S230. If a duplicate record corresponding to the to-be-updated file is found, the procedure returns to S250.

In step S230, the prompt unit 160 generates a warning message to inform users to input updating data for updating the to-be-updated file. The warning message may be an animation or some other interesting image displayed on the display 170. In another embodiment, the message may be an audible message, output by the speaker (not shown).

In step S240, the processor 150 updates the to-be-updated file according to the inputted data which is generated in response to the user operations, and the recording unit 120 creates a duplicate record in relation to the updating data.

In step S250, the processor 150 finds a duplicate record to update the to-be-updated file.

In step S260, the processor 150 further detects whether the to-be-updated file has already been updated. If yes, the procedure ends. If no, the procedure returns to step S230. In the embodiment, the updating system 100 provides a special key for the completion of the updating procedure, the processor 150 determines that the to-be-updated file has not been updated until the special key is activated.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An updating system for updating a to-be-updated file, comprising;
an input unit adapted to generate updating data for updating the to-be-updated file in response to users operations;
a processor adapted to update the to-be-updated file using the updating data generated in response to users operations; and
a recording unit adapted to create a duplicate recording for recording the updating data during the procedure of updating the to-be-updated file;
wherein if the updating system is powered off before the to-be-updated file has been updated, the processor obtains the created duplicate recording and updates the to-be-updated file using the updating data recorded in the duplicate record when the updating system is powered on to update the to-be-updated file again.

2. The updating system of claim 1, further comprising a storage unit for storing the created duplicate recording.

3. The updating system of claim 2, wherein the created duplicate recording is named with the combination of the name of the to-be-updated file and the time of the duplicate record being created.

4. The updating system of claim 2, further comprising a searching unit, wherein the searching unit determines whether a duplicate recording corresponding to the to-be-updated file has been stored in the storage unit, and the processor obtains the created duplicate record and updates the to-be-updated file using the updating data recorded in the duplicate record when a duplicate record corresponding to the to-be-updated file is found.

5. The updating system of claim 4, wherein the processor updates the to-be-updated file using the updating data generated in response to users operations when no duplicate record corresponding to the to-be-updated file is found.

6. The updating system of claim 1, wherein the processor further detects whether the to-be-updated file has been updated and generates a warning if the to-be-updated file has not been updated.

7. The updating system of claim 6, further comprising a prompt unit, wherein the prompt unit generates a warning message to inform users to input updating data for updating the to-be-updated file in response to the warning.

8. An updating method applied in an updating system for updating to-be-updated file, the method comprising:
generating updating data for updating the to-be-updated file in response to users operations;
updating the to-be-updated file using the updating data generated in response to users operations, and creating a duplicate record for recording the updating data during the procedure of updating the to-be-updated file; and
if the updating system is powered off before the to-be-updated file has been updated, obtaining the created duplicate record and updating the to-be-updated file using the updating data recorded in the duplicate record when the updating system is powered on to update the to-be-updated file again.

9. The updating method according to claim 8, further comprising:
storing the created duplicate record, wherein the created duplicate record is named with the combination of the name of the corresponding to-be-updated file and the time of the duplicate record being created.

10. The updating method according to claim 9, further comprising:
determining whether a duplicate record corresponding to the to-be-updated file has been stored when the updating system is activated to update the to-be-updated file;
obtaining the created duplicate record and updating the to-be-updated file using the updating data recorded in the duplicate record when a duplicate record corresponding to the to-be-updated file is found; and
updating the to-be-updated file using the updating data generated in response to users operations when no duplicate record corresponding to the to-be-updated file is found.

11. The updating method according to claim 8, further comprising:
detecting whether the to-be-updated file has been updated; and
generating a warning message to inform users to input updating data for updating the to-be-updated file when the to-be-updated file has not been updated.
